(19) United States
(12) Patent Application Publication
(10) Pub. No.: US 2016/0379516 A1
(43) Pub. Date: Dec. 29, 2016

(54) Career Path Guidance Platform

(71) Applicant: Steppingblocks, LLC, Alpharetta, GA (US)

(72) Inventor: Carlo Andres Martinez, Atlanta, GA (US)

(21) Appl. No.: 15/190,707

(22) Filed: Jun. 23, 2016

Related U.S. Application Data
(60) Provisional application No. 62/185,030, filed on Jun. 26, 2015.

(51) Int. Cl. G09B 19/00; G09B 5/02; G06F 17/30

(52) U.S. Cl. CPC G09B 19/00; G06F 17/3053; G09B 5/02

(57) ABSTRACT

Disclosed is a computer implemented method of providing career path guidance. The method may include receiving historical data associated with a plurality of individuals. Further, the method may include analyzing the historical data in order to identify a plurality of career paths corresponding to the plurality of individuals. Further, each individual may be associated with one or more career paths. Additionally, a career path may include a plurality of milestones. Accordingly, the method may further include receiving a target career goal from a user and identifying one or more potential career paths from the plurality of career paths based on presence of one or more milestones associated with the target career goal in the one or more potential career paths. Accordingly, the method may further include presenting the one or more potential career paths to the user.

### RELATED APPLICATION

Under provisions of 35 U.S.C. §119(e), the Applicant claim the benefit of (PCT or) U.S. provisional application No. 62/185,030, filed Jun. 26, 2015, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to providing career path guidance to users. More specifically, the disclosure relates to methods and systems for identifying career paths that may enable users to reach a target career goal.

### BACKGROUND

Individuals often have a career goal in mind, but do not know the optimal path to reach the career goal. For example, there are multiple paths to become a vice president (VP) of a company. Some individuals may work their way up from an entry level position, while others may get a degree and enter at a higher level. Further, career titles with the same name may vary vastly, for example, in job description and compensation. For example, a VP of Coca Cola may receive larger compensation than a VP of a small start-up company in its early stages.

Current technology provides little in the way of career path guidance. Some applications may perform a personality test to give guidance as to possible career categories. Other applications my provide guidance as to how to prepare for standardized tests to get into certain post-secondary institutions. However, there is no solution that provides comprehensive guidance from the start of a user's career path to a desired career goal.

### BRIEF OVERVIEW

A career path guidance platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The career guidance platform may receive information pertaining to individuals, their careers, and their paths to their current careers. Information pertaining to the individuals' paths may include education and work experience. This information may aggregated and analyzed to determine career path data as will be defined herein.

In further embodiments, the platform may integrate the information pertaining to individuals with industry information to further detail and annotate the career path data for each individual. Annotations may include, but not be limited to, for example, career milestones. Having a detailed career path data set for a plurality of individuals, the platform may further then analyze the data to build inter-relational connections between, for example, the career milestones of each individuals career paths.

The platform may then be configured to receive user input as to a target goal, the platform may use the integrated information to provide to the user a path to reach the target goal. The path may be based on the aggregated, analyzed, and inter-related career paths of the plurality of individuals that the platform has built.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIGS. 1A-1B illustrate block diagrams of an operating environment consistent with embodiments of the present disclosure;

FIG. 2 is a flow chart of a method for providing a career path guidance platform in accordance with some embodiments;

FIG. 3 illustrates an example of how historic data from different data sources may be integrated and stored in a database of the career guidance platform in accordance with some embodiments;

FIG. 4 illustrates an example of how a plurality of milestones, such as, for example, job positions, with a common title may be differentiated based on industry data in accordance with some embodiments;

FIG. 5 illustrates classification of educational titles by the career guidance platform in accordance with some embodiments;

FIG. 6 illustrates classification of job titles by the career guidance platform in accordance with some embodiments;

FIG. 7 illustrates an exemplary job classification based on which the career guidance platform may be configured to classify job positions in accordance with some embodiments;

FIG. 8 illustrates an exemplary data object scheme based on which the career guidance platform may store historical data corresponding to a plurality of individuals in accordance with some embodiments;

FIG. 9 illustrates a conceptual illustration of an individual's profile in the context of the individual's ‘path;’

FIG. 10 illustrates a conceptual illustration of how multiple individuals' profiles may be related by matching ‘milestones;’

FIG. 11 illustrates a tree format in which a user may provide queries to the career guidance platform in accordance with some embodiments;

FIG. 12 illustrates an exemplary query in a tree format provided to the career guidance platform in accordance with some embodiments;

FIG. 13 illustrates an exemplary interactive visualization of career paths generated by the career guidance platform in accordance with some embodiments;

FIG. 14 illustrates an exemplary visualization of inter-relationships between career paths generated by the career guidance platform in accordance with some embodiments;

FIGS. 15 and 16 illustrate visualization of analysis of aggregated career paths in accordance with some embodiments;

FIG. 17 illustrates a flow chart for providing analytics to the user;

FIG. 18 illustrates a representation of an intelligent career path as determined by the platform; and

FIG. 19 illustrates a flow chart of a method for providing a career path guidance platform in accordance with some embodiments; and

FIG. 20 is a block diagram of a system including a computing device for performing the method of FIG. 2 and FIG. 19.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of giving a path to the career goal, embodiments of the present disclosure are not limited to use only in this context. For example, the platform may enable users to explore various career paths for various careers, for example, to determine where

### I. Platform Overview

Consistent with embodiments of the present disclosure, a career path guidance platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

The career path guidance platform may be used by individuals or companies to provide users with and understanding of possible career paths to reach a desired career goal. After gathering a host of information for individuals and their corresponding career paths, the platform may analyze the information to provide optimal paths (e.g., shortest time, least amount of relocation, etc.) to reach the desired career goal.

The platform may aggregate data from various individuals from a plurality of careers. For example, the platform may receive information regarding individuals' educational backgrounds (e.g., fields of education, educational institutions, education type) and prior work experience (e.g., job titles, job descriptions, job durations, and company profiles). Further individuals' information (e.g., name, geographical information, skills, affiliations, patents, publications, military status, certifications, tests scores, grades, extracurricular activities, interests, and chronological information associated with the individuals) may be received by the platform.

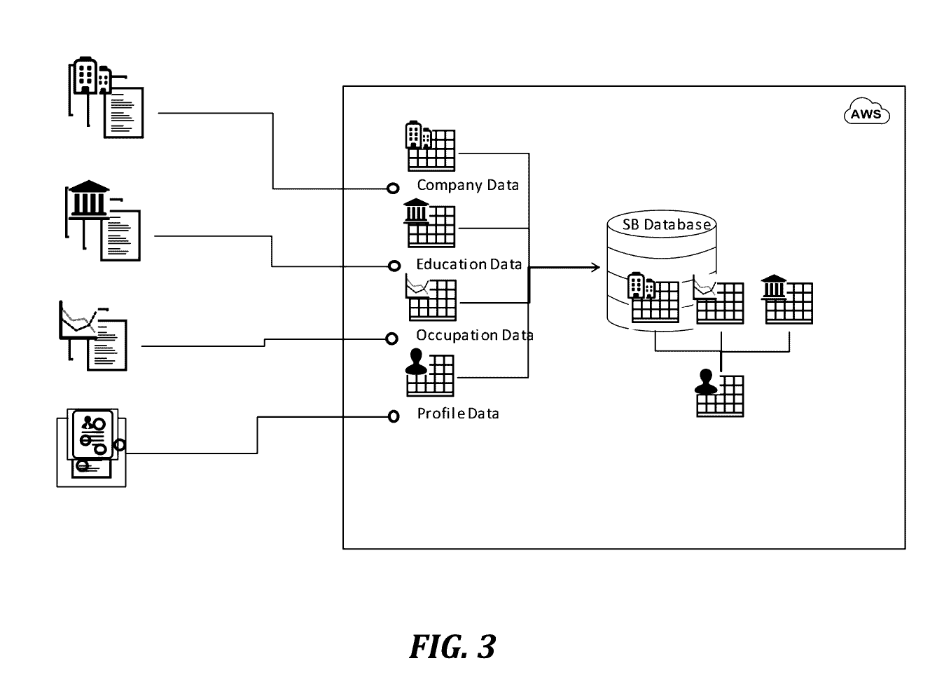

Such information may be received from sources such as, for example, direct individual input, integration with career market companies and organizations, (e.g., LinkedIn, Monster, CareerBuilder), and from internet searching/crawling of public data as exemplarily illustrated in FIG. 3. The platform may use the information to create profiles for each individual that corresponds to the individual's career path. Each individual's career path may illustrate one way to reach every milestone (e.g., job) in the individual's career path. Embodiments may further inter-relate the career path milestones, creating bridges between each individuals' career paths. In this way, and as will be further detailed below, upon presentation of the career path data, on may see the different career moves different individuals from similar career milestones.

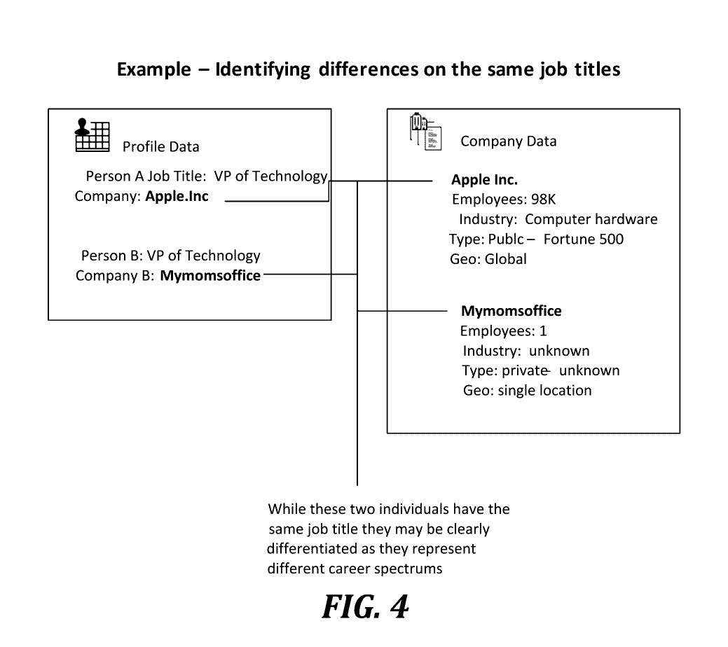

The platform may integrate individual profiles with industry information. For example, educational firmographics, company/institution firmographics, and general industry data (e.g., salary information) may be integrated with the individuals' data. In this way, the platform may differentiate careers having the same title (e.g. vice president (VP). For example, the compensation and experience of a vice president of a Fortune 500 company may vary greatly from the vice president of a small company as exemplarily illustrated in FIG. 4. The platform may use company firmographics to differentiate between same job titles from varying company types.

The platform may further provide classification for careers. For example, an individual's resume may include “real estate tax accountant” as one job within the individual's career path. “Real estate tax accountant” is not available on O*net, the US government's list of job classifications. The platform may break such a job title down to further create categories relevant to more specific career descriptions.

Embodiments of the present disclosure may enable a user to select a career goal, for example, by providing a user interface capable of receiving, for example, a job title, a job title area, an industry, and a location. For example, the career goal may be vice president of a manufacturing company in the Southeast US. The platform may use the aggregated data, along with integrated industry information, to provide ideal paths for the user to take to reach the goal. For example, the platform may provide profiles of individuals that reached the career goal in the shortest time. As another example, the platform may provide profiles of individuals who reached the goal according to other metrics (e.g., least expensive education or greatest income acquired before the career goal was reached). In some embodiments, the platform may perform an algorithm to combine individuals' paths to optimize an ideal path (e.g., shortest time).

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

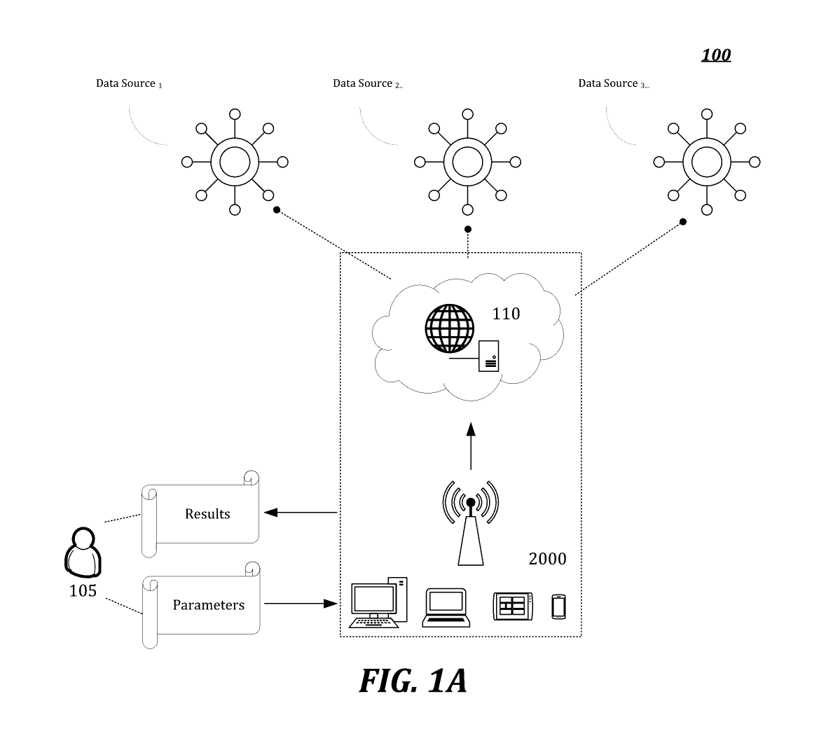

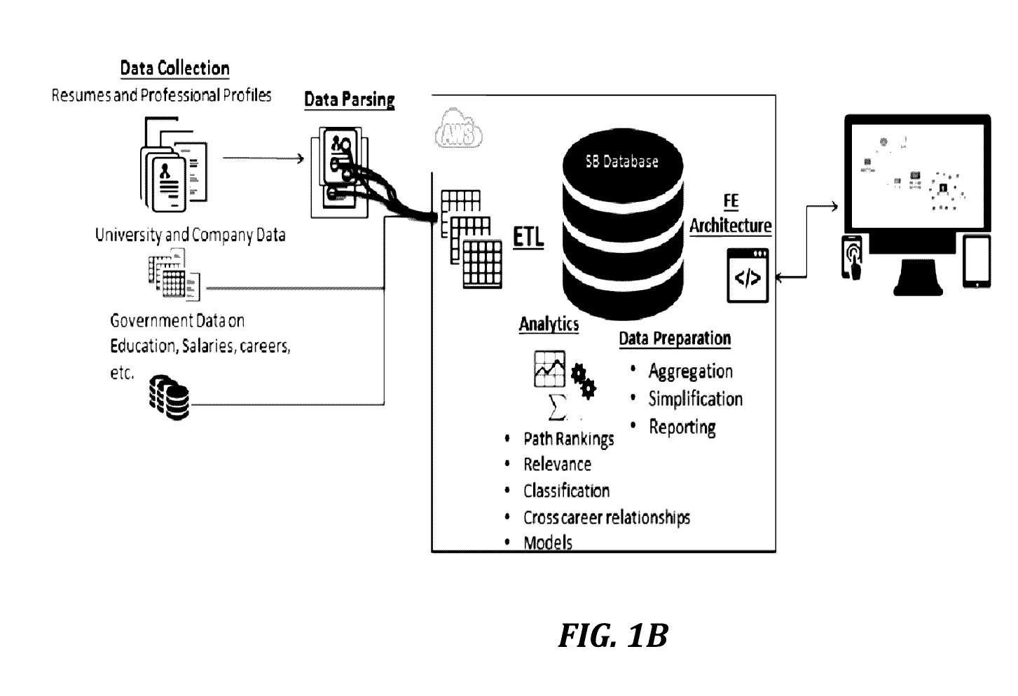

FIG. 1 illustrates one possible operating environment through which a platform consistent with embodiments of the present disclosure may be provided. By way of non-limiting example, a career path guidance platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 2000. One possible embodiment of the software application may be provided by the Steppingblocks™ suite of products and services provided by Steppingblocks, LLC.

Centralized server 110 may be configured to collect data from various databases (resumes, professional profiles, universities, companies, governments, and the like). Server 110 may further be configured to parse, analyze, and inter-relate the data as will be described in greater detail below.

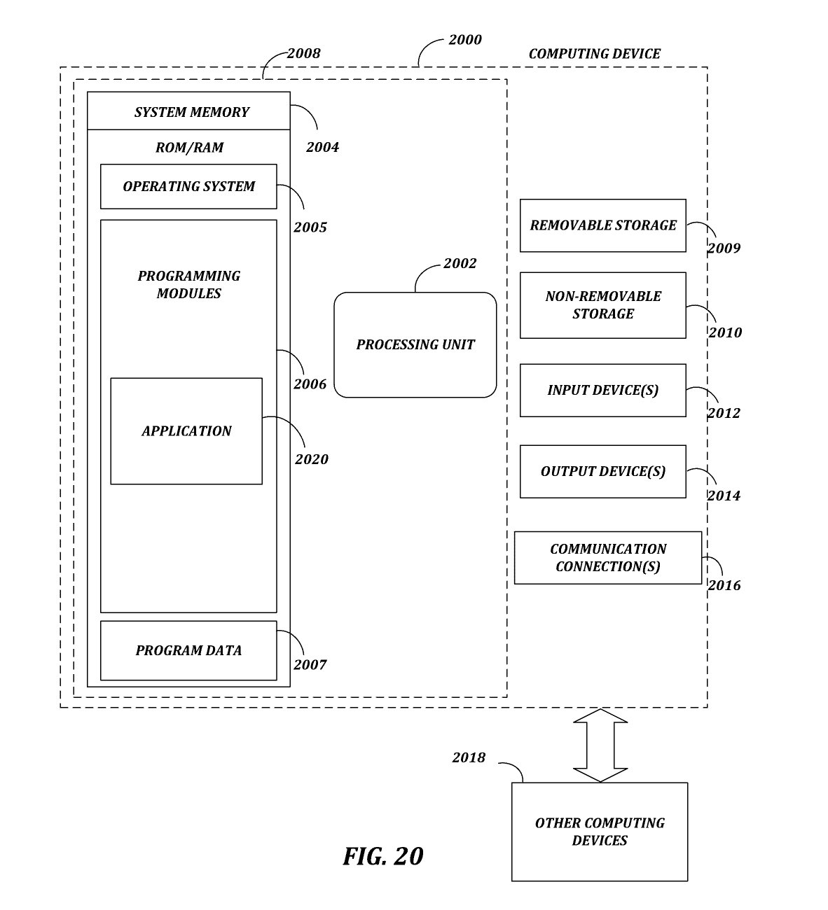

User 105 may use a computing device 2000 to communicate with server 110 through a user interface. The user interface may enable user 105 to input a plurality of parameters and receive, in graphic and textual form, a plurality of results. As will be detailed with reference to FIG. 20 below, the computing device through which the platform may be accessed may comprise, but not be limited to, for example, a desktop computer, laptop, a tablet, or mobile telecommunications device.

### III. Platform Operation

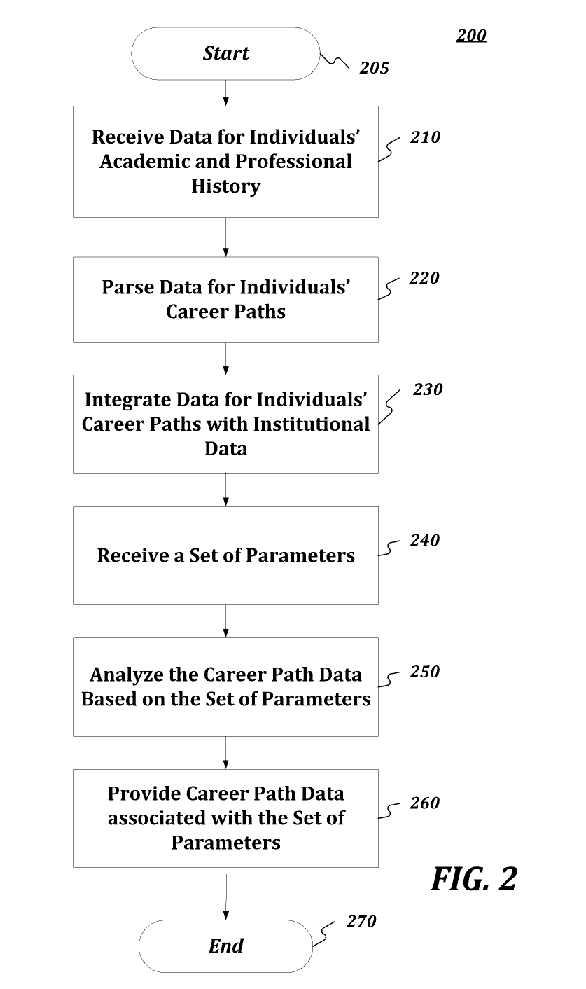

FIG. 2 is a flow chart setting forth the general stages involved in a method 200 consistent with an embodiment of the disclosure for providing a career path guidance platform 100. Method 200 may be implemented using a computing device 2000 as described in more detail below with respect to FIG. 20.

Although method 200 has been described to be performed by platform 100, it should be understood that computing device 2000 may be used to perform the various stages of method 200. Furthermore, in some embodiments, different operations may be performed by different networked elements in operative communication with computing device 2000. For example, server 110 may be employed in the performance of some or all of the stages in method 200. Moreover, server 110 may be configured much like computing device 2000.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where platform 100 may receive data corresponding with individuals, their careers, and their career paths. For example, platform 100 may receive target data, such as, for example, resumes and professional profiles of individuals. Accepted file types may include, for example, but not limited to, MS Word documents, HTML, XML and .txt files. Sources for data may include, for example, but not limited to, user-contributed data (‘organic data’). For example, individuals may upload data directly to the platform.

Other sources for data may include public data (e.g., data harvested from public resumes and professional profiles). Public data may be acquired via scrapers (e.g., Python and Outwit applications) that obtain publicly available resumes and professional profiles. In some embodiments, public data may be used only for analytics and not for generating profiles, as further discussed below. Further sources may include partnerships with companies in the career market (e.g., Monster, CareerBuilder, and LinkedIn). Partnership data may be provided, for example, via an application program interface (API) or via direct file submission (e.g., csv, doc, docx, HTML and txt files).

In some embodiments, mentor information may be provided by individuals. For example, an individual may volunteer tips and recommendations that desire to follow in the mentor's footsteps (e.g., learn as much as you can about reporting using Business Intelligence Tools such as Tableau; know at least a basic level of database structure as all risk data is stored in massive relational databases, etc.). The mentor information may be presented to the user in a plurality of ways, including, but not limited to, for example, graphical and textual representations of the career path undertaken by the mentor.

From stage 210, where platform 100 receives data corresponding with individuals, their careers, and their career paths, method 200 may advance to stage 220 where platform 100 may parse the data. For example, a parsing program (e.g., a Python program) or series of programs may parse all desired attributes from the data. By parsing, platform 100 may identify relevant information from the target data. For example, relevant information may include name, geographical information, fields of education, educational institutions, education type, job titles, job descriptions, job durations, skills, affiliations, patents, publications, military status, certifications, degrees, and companies and company firmographics of the individuals' work histories, tests scores, grades, extracurricular activities, interests, and chronological information associated with the individuals.

In some embodiments, platform 100 may convert Microsoft Word documents to HTML documents before parsing. In further embodiments, the platform may receive data from APIs via JavaScript. The platform may characterize relevant information in groups, such as, for example, personal/path distinct traits, (e.g., name, geographical information, skills, affiliations, patents, publications, military status, certifications, extracurricular activities, and interests), educational history (e.g., education title (major), school/university/institution, beginning and end times, location, and description), and work history (e.g., job title, company/institution, beginning and end times, location(s), and description). The data associated with each individual may comprise an individual's profile.

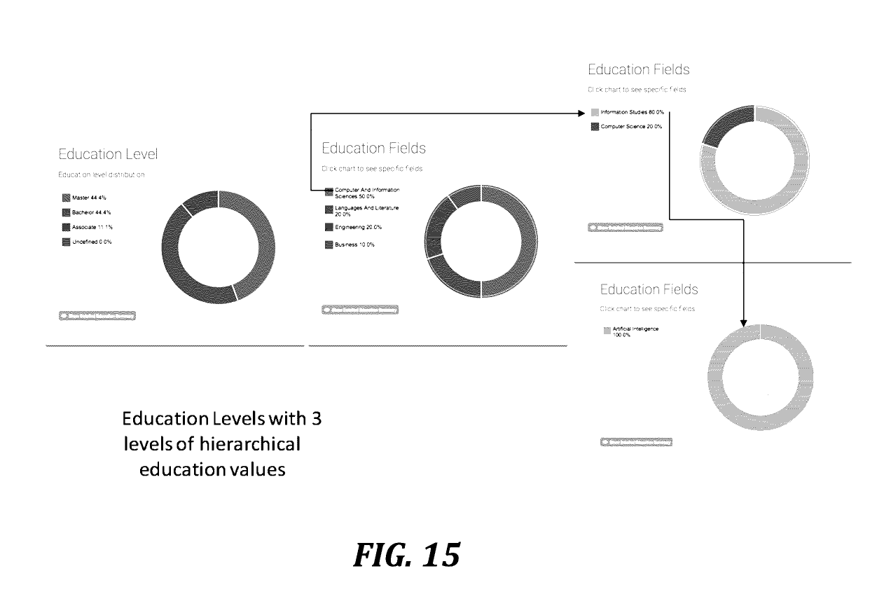

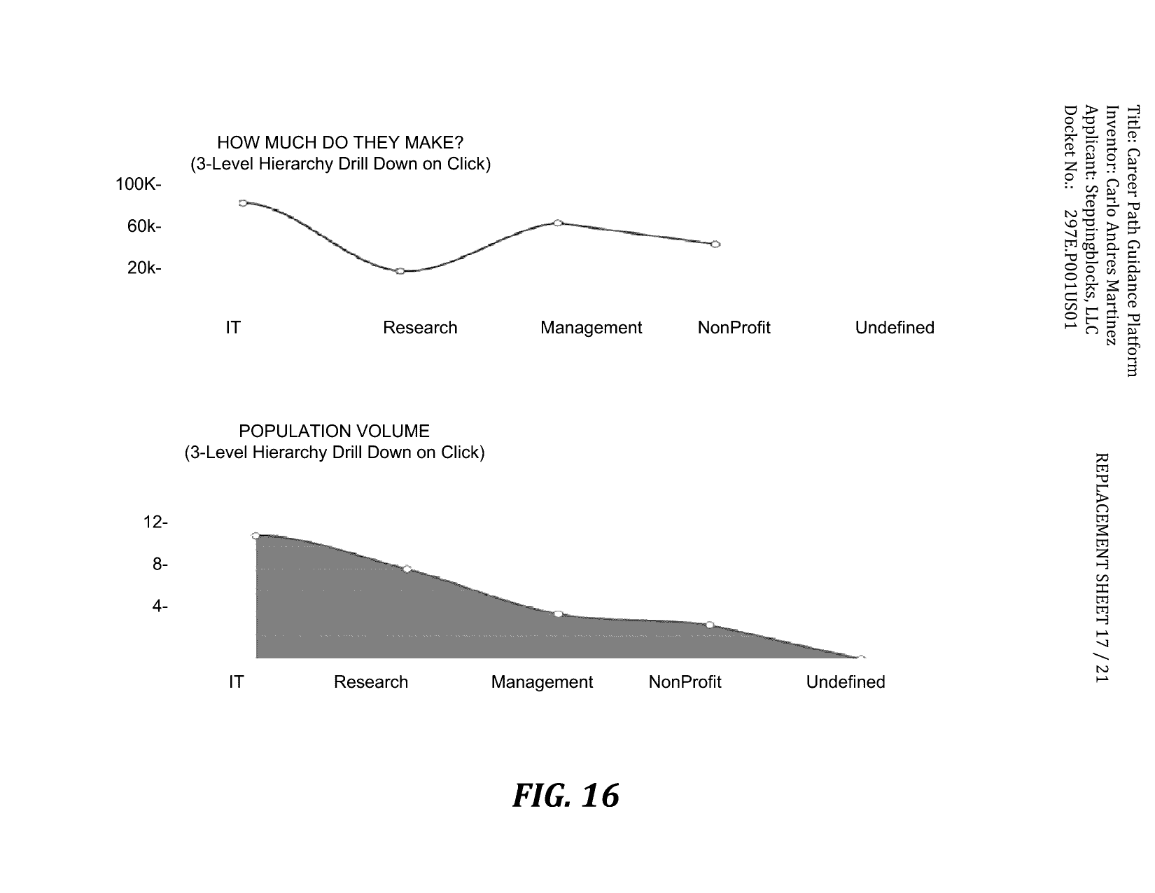

Once platform 100 parses the data in stage 220, method 200 may continue to stage 230 where platform 100 may integrate the relevant individual data with institutional data (e.g., company data, educational institution data, and various available data, including salary, trends, and statistics). For example, platform 100 may first receive company firmographics. The company firmographics may be received from sources such as, but not limited to, Crunchbase, SEC, Yahoo Finance, company websites, or from data purchased from firmographic generators. The firmographic data may enable differentiation between same job titles in different types of firmographic views (e.g., industry, size (revenue), size (sales), public vs private, Fortune 500 indicator, location, and operations footprint). In addition, platform 100 may further receive educational institution-specific firmographics (e.g., rank (US/World), size (number of students), tuition, programs, accreditation, location, and operations footprint. This information may be used, in turn, to provide users with relative metrics and statistics of the various career paths presented as exemplarily illustrated in FIG. 15 and FIG. 16.

Platform 100 may receive educational institution-specific firmographics from, for example, Carnegie, FBLS, and university websites. Platform 100 may further receive general salary and occupation data. The general salary and occupation data may be received from sources, such as, for example, O*Net (occupational information network) and FBLS. General salary and occupation data may include, for example, salaries, occupational trends, educational trends, occupation descriptions, and requirements (e.g., licenses).

The institutional data may be integrated with data from individuals associated with the companies, educational institutions, and general salary and occupation data. Institutional data may be further classified to optimize relevance to users.

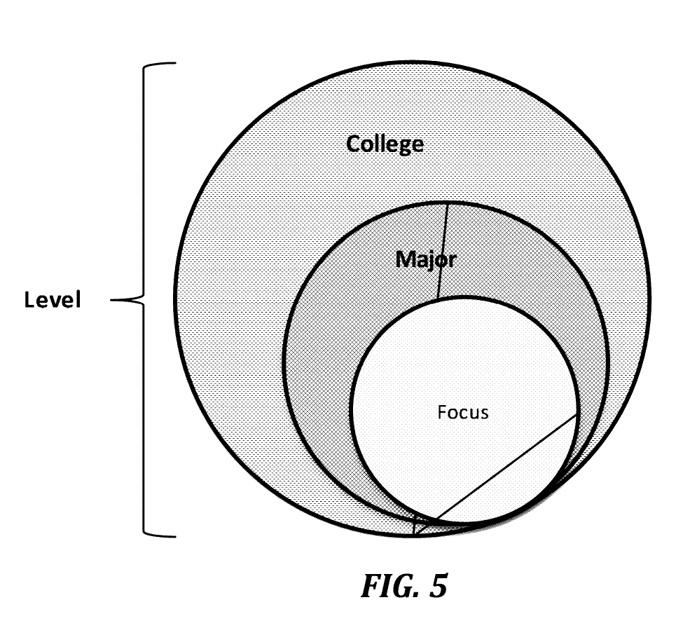

Education may be classified in at least two ways, including education level and education type. Education level may represent the level achieved, which qualifies the educational degree (e.g., certification, associate, bachelors, masters, Ph.D., etc.). Education type may represent the field of study. For example, education type may comprise a ‘college,’ (e.g., business, arts, science, etc.). Within the ‘college,’ an education type may be described by a major (e.g., finance, accounting, marketing, etc.). Within the major, an educational type may be described by a ‘focus’ (e.g., focus on financial institutions and banking) as exemplarily illustrated in FIG. 5.

Job classification may be described in categories including, but not limited to, job function (e.g., worker, maker, manager, analyst), job title seniority (e.g., Senior, Junior, VP), and job title occupational classification (representing the US generally accepted job classification according to the Federal Bureau of Labor Statistics (FBLS). Job classifications may further include ‘core descriptors’ and ‘sub core descriptors’.

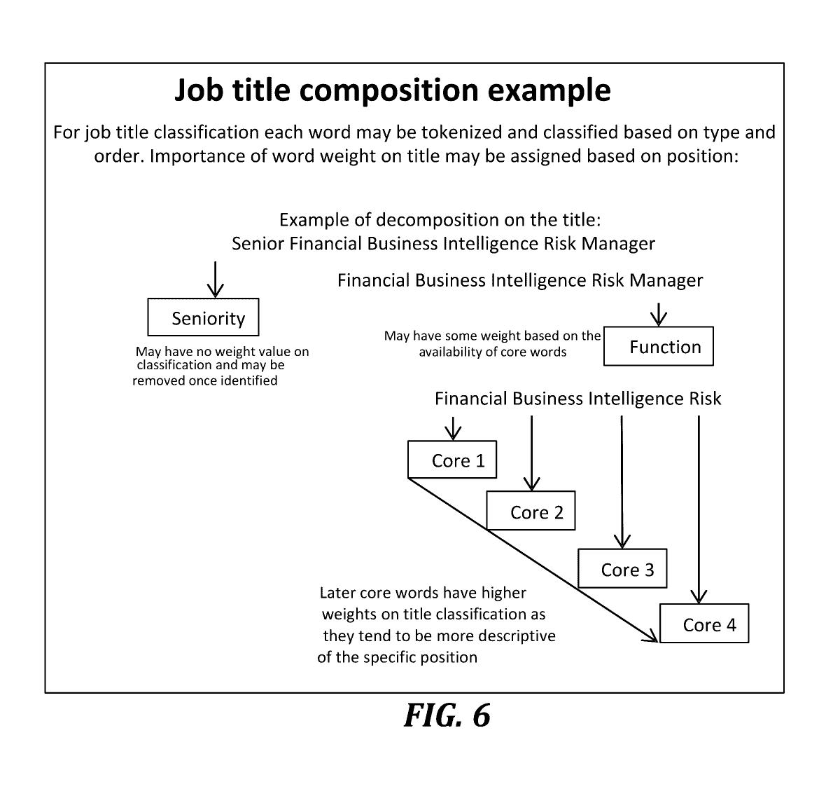

As an example, as illustrated in FIG. 6, a job title may be “Senior Financial Business Intelligence Risk Manager.” “Senior” may represent the job seniority. “Manager” may represent the job function. “Financial” may represent ‘Core 1,’ “Business” may represent ‘Core 2,’ “Intelligence” may represent ‘Core 3,’ and “Risk” may represent ‘Core 4’. In some embodiments, a heavier weight on job title classification may be given to later core words, as they may tend to be more descriptive of the position. For example, “Risk” may give a better understanding of the position than “Financial,” “Business,” and “Intelligence”.

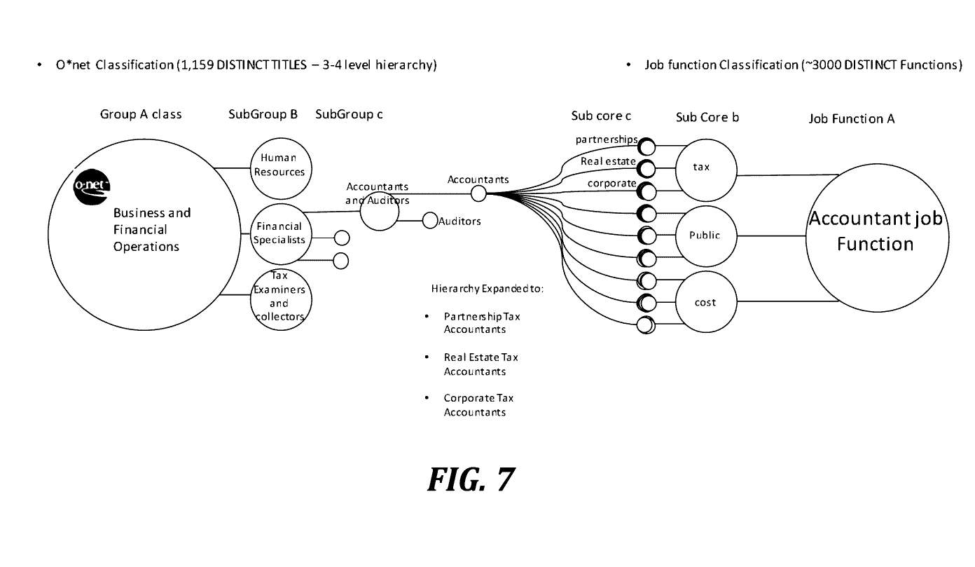

Raw data from the job titles received from a resume are often unstructured and unrelatable. For example, two job titles that may relate to the same actual job category may have very different text descriptions. In order to compare these two titles, they will need to be categorized in the same classification. In order to group resume job titles into meaningful categories for classification, a data dictionary reference may be created, leveraging US accepted title classifications from the FBLS' O*net. This is a three level occupational hierarchy which may be further expanded by a process of identification of job functions within the platform's database titles. Each one of the job titles produced by a resume may be placed into the best fitting class. FIG. 7 illustrates an example of how a classification may be created and added to a hierarchy within the database. In this example, partnership does not exist in O*net's classification hierarchy. A job functions dictionary may be built using the raw job titles from the professional profiles obtained. The dictionary may be created a “bag of words” classification identifying elements associated with a job function (e.g., for the accountant job function find all the words that are associated in job titles such as tax, partner, partnership, consultant, and the like, and any combinations thereof). The generated job functions classification may expand word associations to a specific job function, which in turn may allow the expansion of the O*net government titles classification).

In cases where a job title does not match any words in the O*net hierarchy or the platform's expanded job functions (‘Job Functions dictionary’) a learning process of word associations may be used to learn the unknown job title, for example, by identifying the most relevant (e.g., 3) words and associate it with a category.

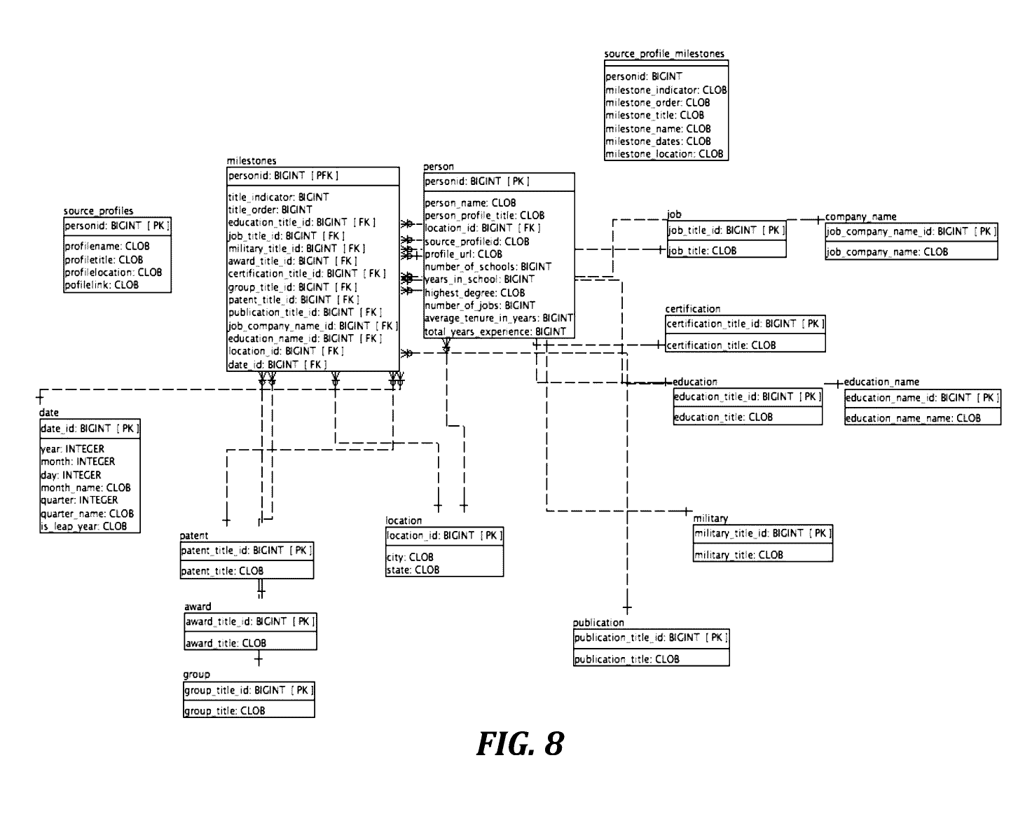

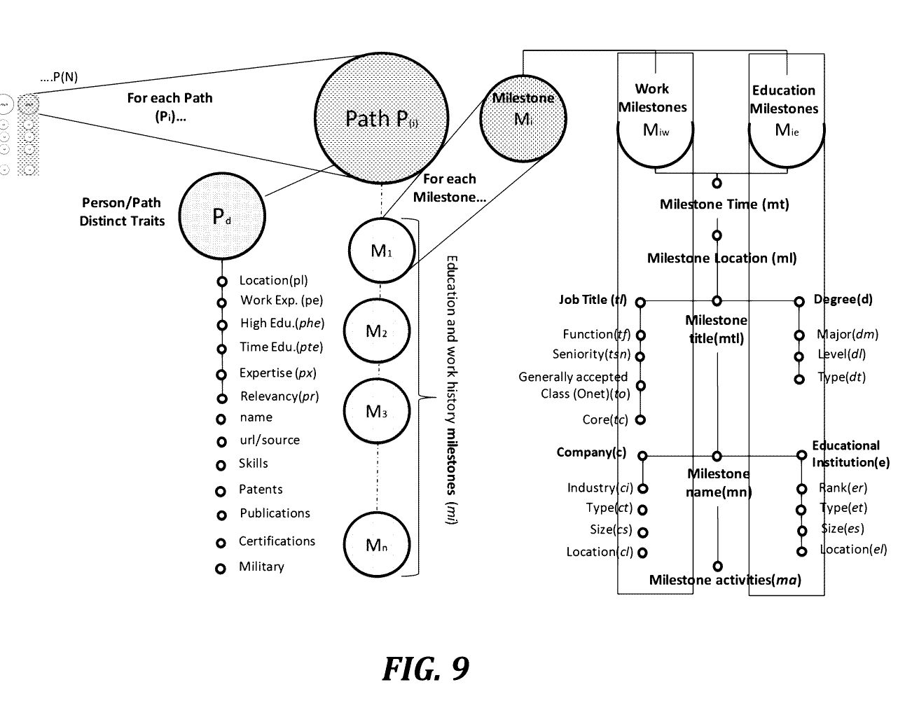

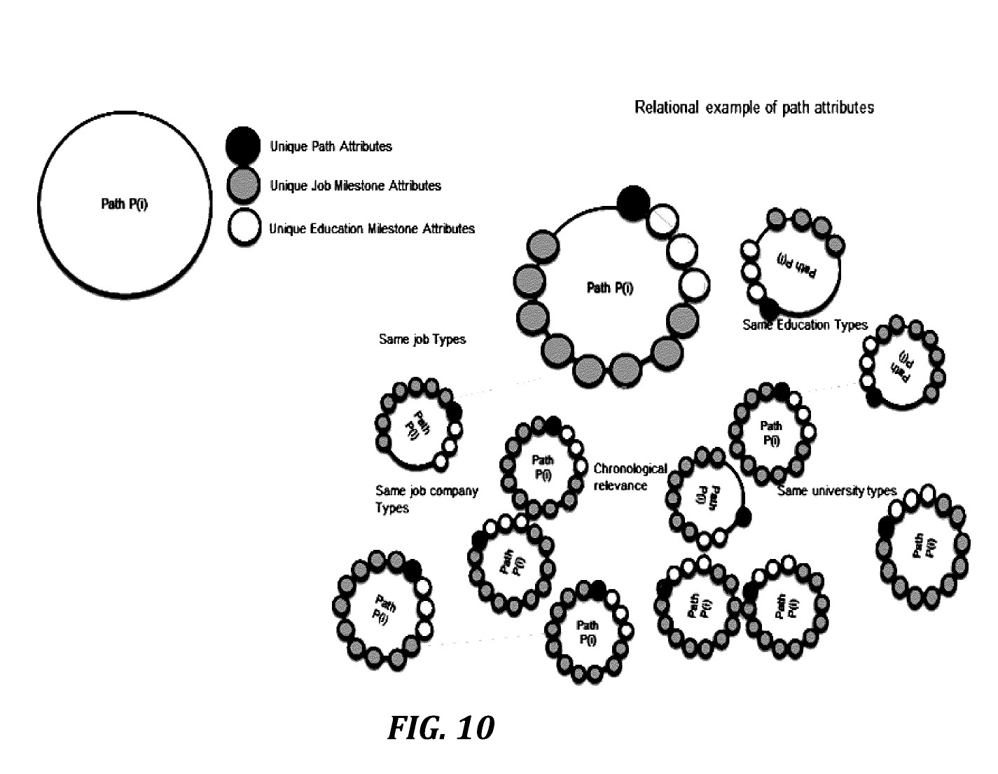

FIG. 8 illustrates an integrated data model or a data object schema 800 for an individual's profile. FIG. 9 illustrates a conceptual illustration 900 of an individual's profile in the context of the individual's ‘path,’ P₍ᵢ₎. The individual's path may be marked by discreet ‘milestones’, Mᵢ, which may correspond to, for example, work milestones and education milestones. FIG. 10 illustrates a conceptual illustration 1000 of how multiple individuals' profiles may be related by matching ‘milestones.’

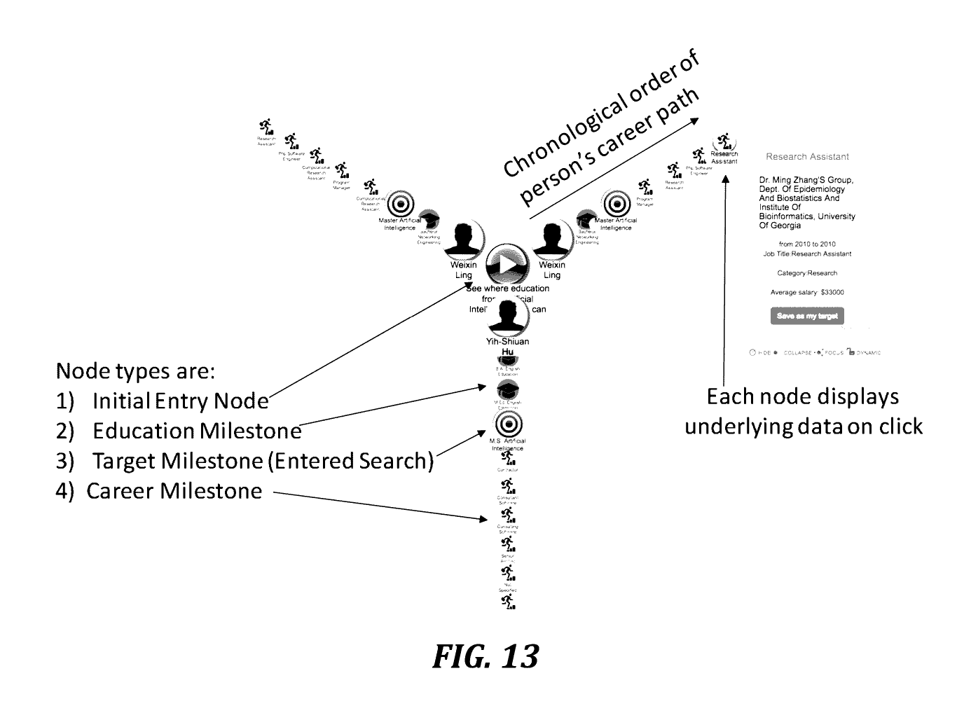

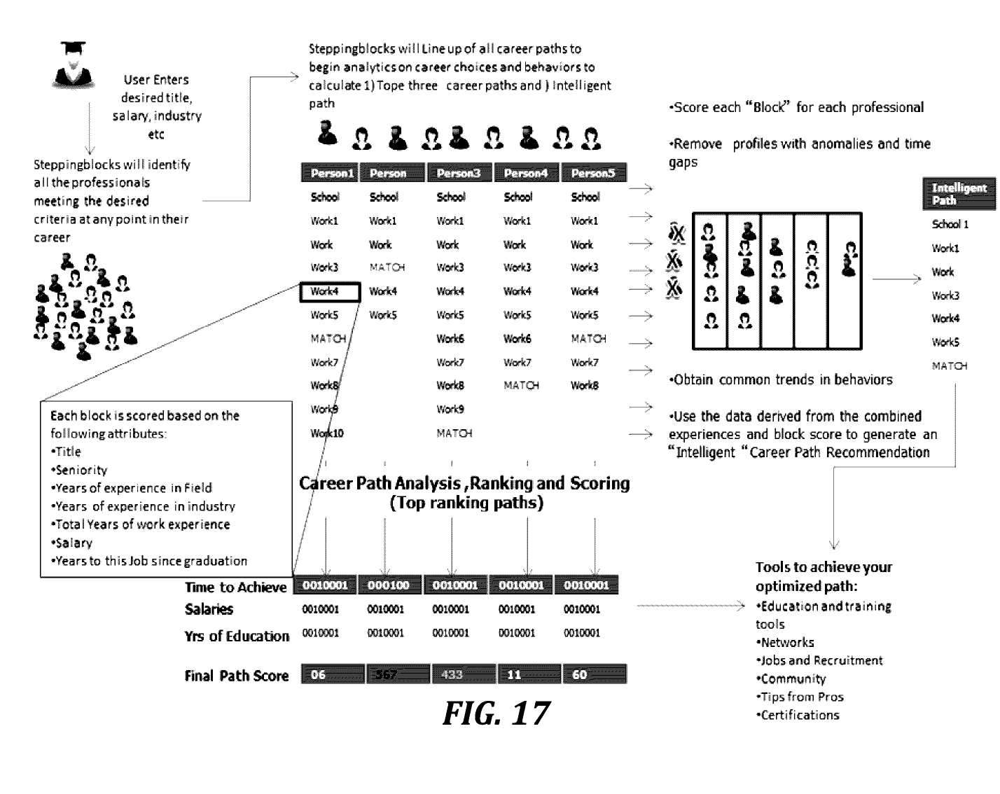

After platform 100 integrates relevant individual data with institutional data in stage 230, platform 100 may provide analytics to the user. FIG. 17 illustrates a flow chart 1700 for providing analytics to the user. The user may use these analytics in an ‘exploratory’ fashion or, in some embodiments, the platform may first receive criteria via user input, as illustrated in stage 240. For example, a user may provide the platform with a job title, job area, industry and location. Accordingly, the platform may present an interface for receiving criteria via user input. The platform may then identify all individuals that match the criteria in stage 250 and the platform may then show the user career paths for individuals that arrived at careers matching the user's criteria in stage 260 as exemplarily illustrated in FIG. 13.

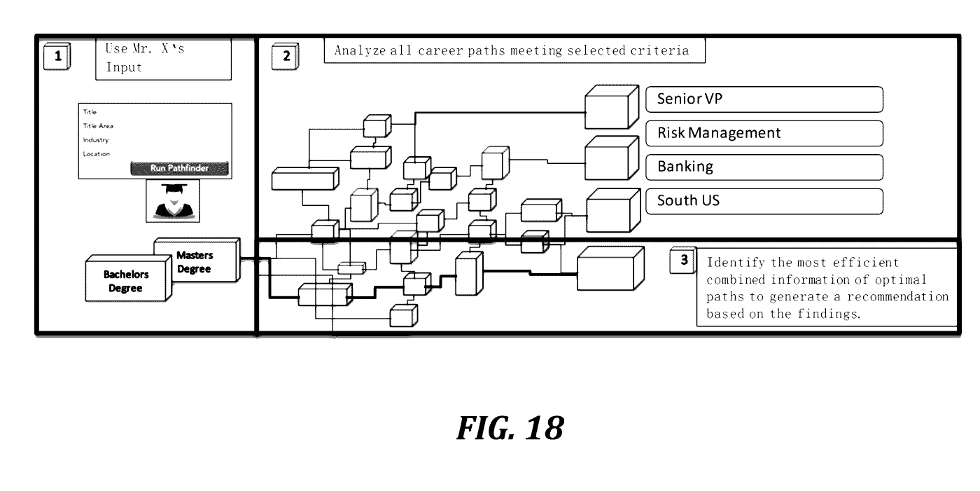

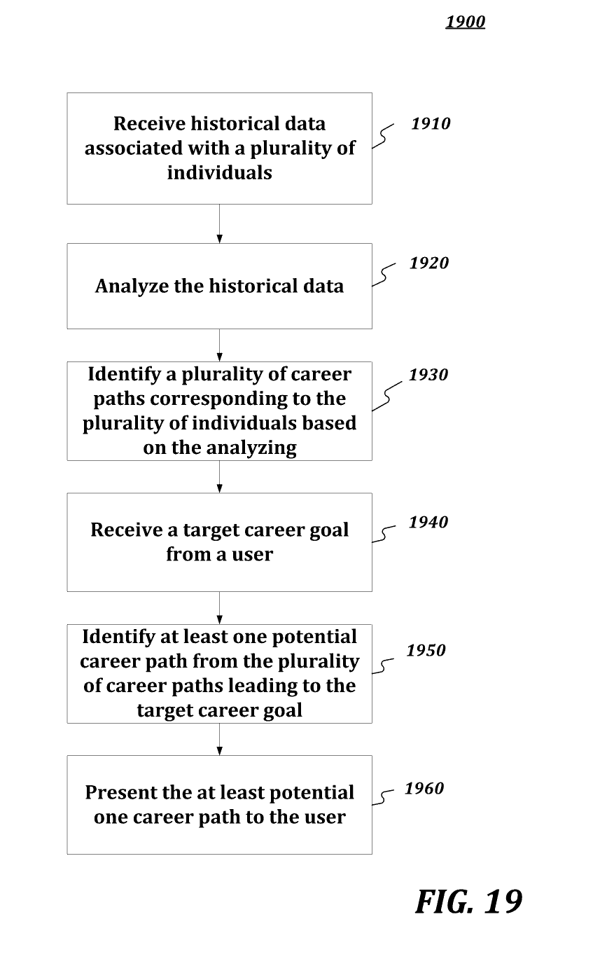

In further embodiments, the platform may determine ‘best’ career paths (e.g., shortest in time, lowest education cost, etc.) and provide the user with such ‘best’ career paths. In further embodiments, the platform may create an ‘intelligent career path,’ by combining individuals' career paths to create an optimal path. FIG. 18 illustrates a representation of an intelligent career path 1800 as determined by the platform. ‘Blocks’ may represent individual milestones. In some embodiments, the varying width and height of the blocks may represent varying time engaged in the milestones and the varying difficulty in reaching the milestones.

In some embodiments, platform 100 may further provide information on each ‘block.’ For example, each block may provide a job title, company, expected salary, average number of years in the block, location, and mentor notes.

In some embodiments, platform 100 may further provide general target information, such as, for example, an overall list of skills needed to reach the target, links to jobs and training recommended, information on companies hiring for such jobs, ways to contact mentors and education scholarships available matching user's criteria.

After analyzing the data and providing potential paths to the user in stage 240, method 200 may end at 270.

In accordance with some other embodiments, a method 1900 of providing career path guidance in accordance with some embodiments may be provided. Further, the method 1900 may be a computer implemented method 1900. Accordingly, one or more steps of the method 1900 may be performed by a computer system.

The method 1900 may include a step 1910 of receiving historical data associated with a plurality of individuals. In general, the historical data may include any data corresponding to an individual that may indicate engagement with one or more activities such as, professional and/or personal activities. Accordingly, historical data may include data regarding activities such as, a name of an activity, duration of the activity, start and end times corresponding to the activity, location of performing the activity, name of an organization where the activity was performed, designation of the individual while performing the activity, skills associated with the activity, remuneration received for performing the activity, monetary cost incurred by the individual for performing the activity, performance metrics associated with the activity, mentorship data associated with the activity and so on. In some embodiments, the nature of such historical data may be such that the career guidance platform may be enabled to characterize a career path of the individual based on the historical data. In an exemplary instance, historical data associated with an individual may include one or more of education history and work history.

In general, the education history may include data representing any activity performed by the individual leading to improvement in one or more of knowledge, skill and experience of the individual in a field of endeavor. Accordingly, the historical data may include education history such as names of schools, colleges and/or universities attended by the individual, time of joining and completing a course, duration of the course, place of study, academic performance, certifications obtained and so on.

In general, work history may include data representing any productive activity performed by the individual. In some instances, the work history may include data about activities which were performed in return for a monetary compensation, such as a salary. In other instances, the work history may include data about activities that were performed for non-profit, such as for example, social service or voluntary work.

In some embodiments, the historical data may be extracted from a plurality of profiles corresponding to the plurality of individuals. A profile of an individual may include a document representing data regarding the individual such as name, contact details, address, place of residence, personal interests, professional interests, work experience, educational qualifications, certifications, personal/professional achievements, career goals and so on. In other words, a profile of an individual may be a snapshot of the individual's life as a whole. Examples of the profile may include resumes, bio-data, curriculum vitae etc.

The plurality of profiles may be received by the platform through various means. In some embodiments, the platform may provide a user interface to users for submitting the profiles. For instance, a user interface that may enable users to upload resumes in one or more formats such as word document, Portable Document Format (pdf), XML and so on. Alternatively, the platform may be enabled to receive the plurality of profiles from a data source, such as, a job search portal, professional networking portal, social networking portal etc. In such cases, the platform may be configured to communicate with the data source through an API.

Further, in some embodiments, the plurality of profiles may be available in a variety of file formats. Additionally, the plurality of profiles may also vary with regard to a structure of contents. For example, some of the plurality of profiles may be unstructured or semi-structured, while some other profiles may be structured. A structured profile may, for example, include metadata corresponding to the data. For instance, a job position held by an individual may be indicated by a job title in a profile while a metadata such as “Job Title” may be appended to the actual job title, such as, for example, “Assistant Manager”. Further, in a structured profile, the metadata used may be standardized. On the other hand, in an unstructured profile, such metadata may be absent. Further, if present, such metadata may not be according to a standard vocabulary.

Accordingly, in some embodiments, the platform may be configured to receive the plurality of profiles in different formats with regard to contents and/or file type and extract the historical data. Accordingly, in some embodiments, the platform may be configured to convert a profile from one file type to another file type. For instance, the plurality of profiles in various formats may be converted into a common format such as XML that may be, for example, suitable for further processing. Further, the platform may also be configured to convert a profile from an unstructured and/or semi-structured form to a structured form. For instance, the platform may be configured to analyze contents of a profile and identify metadata corresponding to different portions of the profile. For example, based on set of predefined keywords, the platform may recognize that “CEO” is an instance of a job position. Accordingly, the platform may tag or append “Job Title” with “CEO” resulting in a structured form of the profile. As a result, a profile may be represented by a data structure comprised of metadata identifiers and data values. Further, as shown in FIG. 8, the platform may include an object schema defining data type corresponding to each type of data object that may be comprised in a profile along with metadata identifiers. For instance, a profile may include data objects such as profile name, person, milestones, date, location, job, company and so on. As an example, the object “person” may include the following attributes: personid, person_name, “person profile_title”, “location_id”, “number_of_schools”, “years_in_school”, “highest_degree”, “no_of_jobs”, “average_tenure_in_years”, “total_years_experience” and so on. Further, each of the attributes may be associated with one or more predefined data types such as, CLOB, BIGINT etc. Further, the data object schema may also indicate relationships between two or more data objects. Accordingly, in some embodiments, the platform may be configured to extract historical data from the plurality of profiles and store the historical data in a database in accordance with the object schema.

In some instances, the platform may employ supervised and/or unsupervised machine learning and/or artificial intelligence in order to convert a profile from an unstructured and/or semi-structured form to a structured form. As a result, the platform may be able to assimilate historical data corresponding to the plurality of individuals in a form that may facilitate querying and/or further analysis.

Accordingly, the method 1900 may include a step 1920 of analyzing the historical data. The analyzing may include, for example, identifying a plurality of activities performed by the plurality of individuals as represented in the plurality of profiles. In other words, the platform may be configured to analyze a profile and determine facts related to the activities such as job position held by an individual, duration of the job position, start and end times of the job position, company where the job position was held, location where the job position was held. Further, the analyzing may also include generating a chronological time sequence of the one or more activities. For instance, in a resume, each activity such as school study, college study, university study and work experience may be associated with respective start and end times and/or time durations expressed in days, months or years. Accordingly, the platform may be configured to analyze the start and end times in order to generate the chronological time sequence that may provide an indication of a career path of an individual.

Accordingly, the method 1900 may include a step 1930 of identifying a plurality of career paths corresponding to the plurality of individuals based on the analyzing. Further, a career path may include a plurality of milestones. A milestone may correspond to one or more activities performed by the individual and/or an event corresponding to the individual's history. For example, completion of undergraduate studies, start of a professional course, working as an employee at a company, receiving a professional certification, etc. may be identified as a milestone.

Further, each individual may be associated with one or more career paths. For example, an individual may have simultaneously performed multiple job and/or educational activities leading to multiple career paths. As another example, an individual may have abandoned one field of work and/or study and pursued another unrelated field of work and/or study resulting in multiple disconnected career paths.

Additionally, in some embodiments, each career path corresponding to an individual may be associated with personal traits of the individual as exemplarily illustrated in FIG. 9. Further, in some embodiments, the historical data further may include mentor data provided by an individual of the plurality of individuals. Furthermore, the mentor data may be associated with one or more career paths corresponding to the individual.

In some embodiments, the method 1900 may include a step of storing data indicative of the plurality of career paths in a storage device, in the form of a database. Accordingly, the platform may generate a repository of career paths corresponding to a large number of individuals from various industries and geographical locations. As a result, the platform may create a rich database of information capturing one or more of work history and/or education history in a form that can facilitate processing such as queries issued by users and/or performing analytics.

Accordingly, the method 1900 may include a step 1940 of receiving a target career goal from a user as a query. In some embodiments, the target career goal may include each of a job title, a job title area, an industry, and a location. For example, the target career goal may be “CTO of a technology company in San Francisco”.

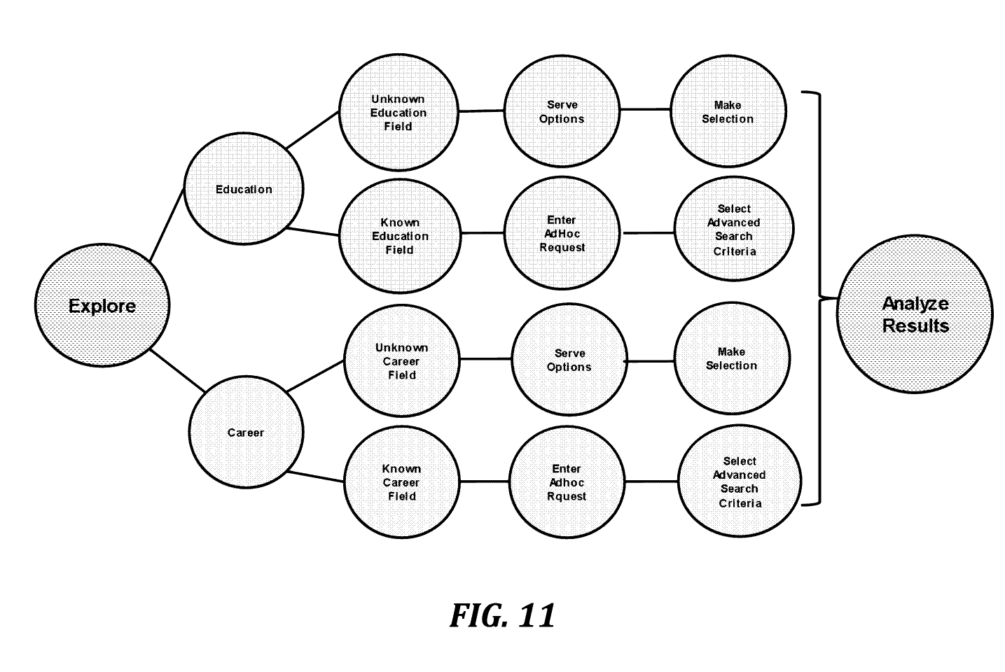

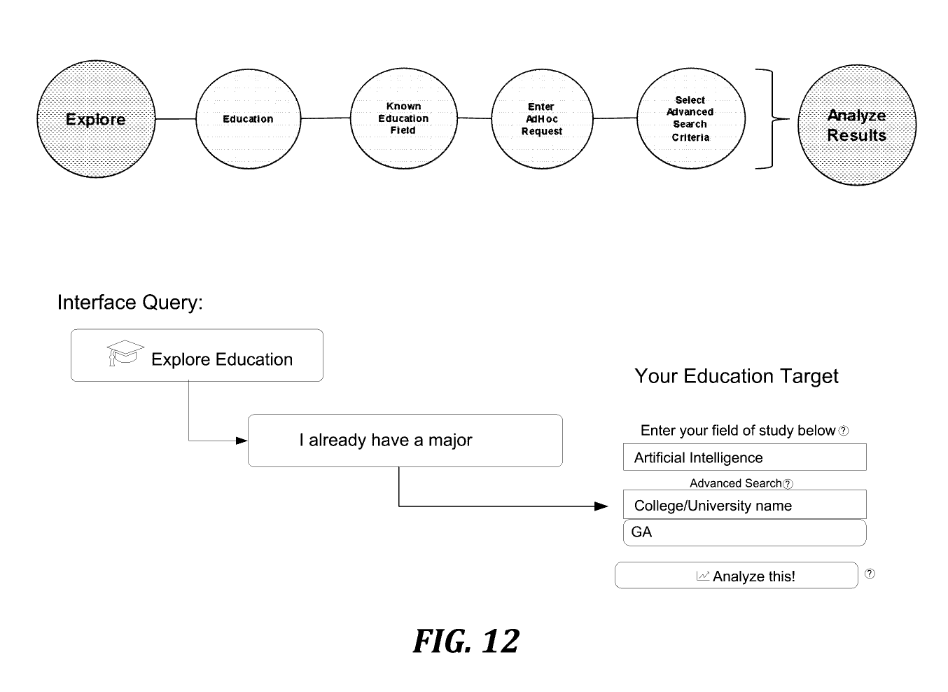

Further, in some embodiments, the query may be received from the user in a tree format as illustrated in FIG. 11. Accordingly, the query may relate to a series of potential entries in the tree format entered by the user. The tree may begin with a global question of interest in education or career. The question may then be broken into a known or an unknown entry selection. If the unknown option is selected the tree may the offer a series of options for the user to select. If the known factor is selected, the user may enter any of the following parameters where at least one parameter may be required: 1) Desired designation; 2) Desired Institution; and 3) Desired geographic location (US State). Accordingly, the user may provide inputs, as exemplarily illustrated in FIG. 12.

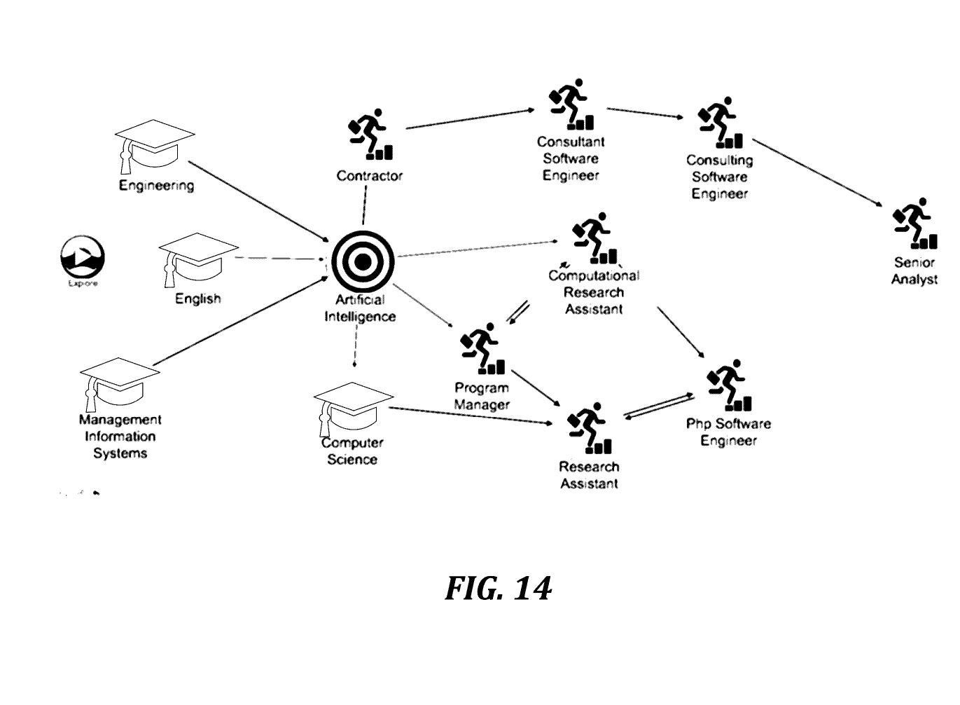

In response to the query, the platform may be configured to access the database comprising the plurality of career paths. Further, the method 1900 may include a step 1950 of identifying one or more potential career paths from the plurality of career paths based on presence of one or more milestones associated with the target career goal in the one or more potential career paths. For instance, the platform may identify all career paths in which at least one milestone satisfies all parameters of the query, i.e. CTO of technology company in San Francisco. In other words, the platform may identify all career paths corresponding to individuals who have held a position of a CTO in a technology company located in San Francisco. Similarly, for the query depicted in FIG. 12, the platform may identify career paths as depicted in FIG. 14.

Further, the method 1900 may include a step 1960 of presenting the one or more potential career paths to the user, such as for example, by displaying the one or more potential career paths. Additionally, in some embodiments, the presenting may include displaying a graphical representation of the one or more career paths as exemplarily illustrated in FIG. 13. Additionally, the graphical representation may be interactive. Accordingly, the user may be able to click on a milestone and obtain further information corresponding to the milestone as shown in FIG. 13.

Further, each milestone comprised in the one or more career paths may be represented as a graphical object. Further, a visual characteristic of the graphical object may be based on one or more metrics associated with the milestone. For example, as illustrated in FIG. 18, career paths may be depicted as rectangular blocks representing milestones interconnected by lines. Further, the dimensions of the rectangular blocks may indicate a difficulty level and/or a time duration associated with the milestone.

In some instances, the one or more potential career paths may be displayed to the user according to a relevancy. For instance, the relevancy of a potential career path to the user may be based on one or more metrics. Accordingly, in some embodiments, the method 1900 may further include receiving one or more metrics from the user. Further, the method 1900 may include ranking each of a plurality of potential career paths based on the one or more metrics. Accordingly, presenting the one or more potential career paths may be based on the ranking.

In some embodiments, the method 1900 may further include receiving at least one criteria associated with a path leading to the target career goal. Further, the method 1900 may include identifying one or more optimal career paths based on the at least one criteria. For instance, as illustrated in FIG. 12, the user may provide criteria such as field of study (“major in Artificial intelligence”) and name of university (“GA”). Accordingly the platform may identify and present career paths which include each of a major in Artificial Intelligence from GA. As a result, the user may be able to view various career options available.

In some embodiments, the method 1900 may further include receiving an entry point, such as, for example, “senior manager”, from the user. Further, identifying the one or more potential career paths may be further based on presence of the entry point in the one or more potential career paths. In other words, career paths including each of “senior manager” and “CEO” may be identified. Accordingly, the one or more potential career paths identified may lead the user from the entry point such as “senior manager” to the target career goal such as “CEO”.

In some embodiments, the historical data further may include industry data associated with the plurality of milestones. The industry data may include at least one of educational firmographics and company firmographics. Further, in some embodiments, the platform may be configured to integrate industry data along with other historical data of individuals as exemplarily depicted in FIG. 3. Accordingly, in some embodiments, the method 1900 may further include receiving the industry data from a source and associating the industry data with the plurality of milestones corresponding to each career path of each individual.

In some embodiments, the method 1900 may further include differentiating a plurality of milestones associated with a common title. Further, the differentiating may be based on the industry data. For instance, as exemplified by FIG. 4, although person A and B each may be associated with a job position with a common title of “VP of technology”, industry data may indicate significant differences between company employing person A and that employing person B. Accordingly, based on parameters such as number of employees, company type (i.e. private/public), geographical footprint etc. the two job positions may be considered different. Accordingly, in some instances, these two job titles may not be considered as equivalent milestones by the career guidance platform.

In some embodiments, the platform may be further configured to identify one or more potential career paths based on an aggregate analysis of the plurality of career paths. For instance, such an aggregate analysis may identify opportunities for a cross over from one career path to another career path.

Accordingly, in some embodiments, the method 1900 may further include identifying a plurality of equivalent milestones across a plurality of career paths. In some embodiments, each milestone may be associated with one or more of a title and a description. Further, identifying the plurality of equivalent milestones may be based on a comparison between one or more of a title and a description of a first milestone with one or more of a title and a description of a second milestone.

For example, in some instances, identical job titles and/or educational titles may be considered as equivalent. However, in some instances, although two milestones may include identical titles, they may be considered non-equivalent based on one or more differentiating parameters as exemplarily illustrated in FIG. 4.

Furthermore, in some instances, although the titles of two milestones may be distinct, they may be considered equivalent based on a common classification to which each of the two titles may belong. Accordingly, in some embodiments, the method 1900 may further include identifying at least one classification corresponding to each milestone. Further, identifying the plurality of equivalent milestones may be based on the at least one classification. For example, each job title may be classified based on the O*net job classification database as exemplarily illustrated in FIG. 7.

However, in some cases, a job title may not have a direct correspondence in a job classification database. Accordingly, in some embodiments, the method 1900 may further include decomposing a title associated with a milestone into a plurality of standardized titles. In some embodiments, the decomposing may be performed based on a database of classifications, such as O*net job classification database. Accordingly, each standardized title may be associated with a classification that may be available in the job classification database. As a result, the platform may determine equivalency between milestones associated with job titles that may not be formed as per a standard vocabulary.

Upon identifying equivalent milestones, the platform may identify cross-over points between two or more career paths. Accordingly, the method 1900 may include forming one or more bridges between the plurality of equivalent milestones of the plurality of career paths. Further, the one or more potential career paths may be based on the one or more bridges. In other words, the user may be presented with career paths that may be synthesized by the platform based on an aggregate analysis of the plurality of career paths.

Additionally, the one or more potential career paths identified as such may be presented to the user according to a relevancy as determined by one or more metrics provided by the user. Accordingly, in some embodiments, the method 1900 may further include receiving one or more metrics from the user. Further, the method 1900 may include ranking each potential career path identified based on the one or more bridges according to the one or more metrics. Further, presenting the one or more potential career paths may be based on the ranking.

### IV. Platform Architecture

The career goal guidance platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although method 200 has been described to be performed by a computing device 2000, it should be understood that, in some embodiments, different operations may be performed by different networked elements in operative communication with computing device 2000.

Embodiments of the present disclosure may comprise a system having a memory storage and a processing unit. The processing unit coupled to the memory storage, wherein the processing unit is configured to perform the stages of method 200.

FIG. 20 is a block diagram of a system including computing device 2000. Consistent with an embodiment of the disclosure, the aforementioned memory storage and processing unit may be implemented in a computing device, such as computing device 2000 of FIG. 20. Any suitable combination of hardware, software, or firmware may be used to implement the memory storage and processing unit. For example, the memory storage and processing unit may be implemented with computing device 2000 or any of other computing devices 2018, in combination with computing device 2000. The aforementioned system, device, and processors are examples and other systems, devices, and processors may comprise the aforementioned memory storage and processing unit, consistent with embodiments of the disclosure.

With reference to FIG. 20, a system consistent with an embodiment of the disclosure may include a computing device, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000′s operation. In one embodiment, programming modules 2006 may include, for example, career classification and intelligent path calculation applications 220. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and nonvolatile, removable and non-removable media implemented in any method or technology for storage of information, such as computer readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., career classification and intelligent path calculation applications 2020) may perform processes including, for example, one or more of method 200's stages as described above. The aforementioned process is an example, and processing unit 2002 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Aspects

Aspect 1. A method of providing career path guidance, wherein the method is a computer implemented method, the method comprising:
a. receiving historical data associated with a plurality of individuals, wherein historical data associated with an individual comprises at least one of education history and work history;
b. analyzing the historical data;
c. identifying a plurality of career paths corresponding to the plurality of individuals based on the analyzing, wherein each individual is associated with at least one career path, wherein a career path comprises a plurality of milestones;
d. receiving a target career goal from a user;
e. identifying at least one potential career path from the plurality of career paths based on presence of at least one milestone associated with the target career goal in the at least one potential career path; and
f. presenting the at least one potential career path to the user.

Aspect 2. The method of aspect 1, wherein the historical data is extracted from a plurality of profiles corresponding to the plurality of individuals.

Aspect 3. The method of aspect 1 further comprising:
a. receiving at least one criteria associated with a path leading to the target career goal; and
b. identifying at least one optimal career path based on the at least one criteria.

Aspect 4. The method of aspect 1 further comprising receiving an entry point from the user, wherein identifying the at least one potential career path is further based on presence of the entry point in the at least one potential career path, wherein the at least one potential career path leads from the entry point to the target career goal.

Aspect 5. The method of aspect 1, wherein the historical data further comprises industry data associated with the plurality of milestones.

Aspect 6. The method of aspect 5, wherein the industry data comprises at least one of educational firmographics and company firmographics.

Aspect 7. The method of aspect 5 further comprising:
a. receiving the industry data from a source; and
b. associating the industry data with the plurality of milestones corresponding to each career path of each individual.

Aspect 8. The method of aspect 5 further comprising differentiating a plurality of milestones associated with a common title, wherein the differentiating is based on the industry data.

Aspect 9. The method of aspect 1 further comprising:
a. identifying a plurality of equivalent milestones across a plurality of career paths; and
b. forming at least one bridge between the plurality of equivalent milestones of the plurality of career paths.

Aspect 10. The method of aspect 9 further comprising identifying at least one classification corresponding to each milestone, wherein identifying the plurality of equivalent milestones is based on the at least one classification.

Aspect 11. The method of aspect 9, wherein each milestone is associated with at least one of a title and a description, wherein identifying the plurality of equivalent milestones is based on a comparison between at least one of a title and a description of a first milestone with at least one of a title and a description of a second milestone.

Aspect 12. The method of aspect 10 further comprises decomposing a title associated with a milestone into a plurality of standardized titles, wherein each standardized title is associated with a classification.

Aspect 13. The method of aspect 12, wherein the decomposing is performed based on a database of classifications.

Aspect 14. The method of aspect 9, wherein the at least one potential career path is based on the at least one bridge.

Aspect 15. The method of aspect 14 further comprising:
a. receiving at least one metric from the user; and
b. ranking each potential career path based on the at least one metric, wherein presenting the at least one potential career path is based on the ranking.

Aspect 16. The method of aspect 1 further comprising:
a. receiving at least one metric from the user; and
b. ranking each of a plurality of potential career paths based on the at least one metric, wherein presenting the at least one potential career path is based on the ranking.

Aspect 17. The method of aspect 1, wherein the target career goal comprises each of a job title, a job title area, an industry, and a location.

Aspect 18. The method of aspect 1, wherein the presenting comprises displaying a graphical representation of the at least one career path, wherein each milestone comprised in the at least one career path is represented as a graphical object, wherein a visual characteristic of the graphical object is based on at least one metric associated with the milestone.

Aspect 19. The method of aspect 1, wherein each career path corresponding to an individual is associated with personal traits of the individual.

Aspect 20. The method of aspect 1, wherein the historical data further comprises mentor data provided by an individual of the plurality of individuals, wherein the mentor data is associated with at least one career path corresponding to the individual.

Aspect 21. A system for providing career path guidance, the system comprising:
a. a communication module configured to:
i. receive historical data associated with a plurality of individuals from at least one data source, wherein historical data associated with an individual comprises at least one of education history and work history;
ii. receive a target career goal from a user device associated with a user; and
iii. transmit at least one potential career path to the user;
b. a processing module configured to:
i. analyze the historical data;
ii. identify a plurality of career paths corresponding to the plurality of individuals based on the analyzing, wherein each individual is associated with at least one career path, wherein a career path comprises a plurality of milestones; and
iii. identify the at least one potential career path from the plurality of career paths based on presence of at least one milestone associated with the target career goal in the at least one potential career path;
and
c. a storage module configured to store the plurality of career paths.

Aspect 22. The system of aspect 21, wherein the processing module is further configured to extract the historical data from a plurality of profiles corresponding to the plurality of individuals.

Aspect 23. The system of aspect 21, wherein the communication module is further configured to receive at least one criteria associated with a path leading to the target career goal, wherein the processing module is further configured to identify at least one optimal career path based on the at least one criteria.

Aspect 24. The system of aspect 21, wherein the communication module is further configured to receive an entry point from the user, wherein the processing module is configured to identify the at least one potential career path based further on presence of the entry point in the at least one potential career path, wherein the at least one potential career path leads from the entry point to the target career goal.

Aspect 25. The system of aspect 21, wherein the historical data further comprises industry data associated with the plurality of milestones.

Aspect 26. The system of aspect 25, wherein the industry data comprises at least one of educational firmographics and company firmographics.

Aspect 27. The system of aspect 25, wherein the communication module is further configured to receive the industry data from a source, wherein the processing module is further configured to associate the industry data with the plurality of milestones corresponding to each career path of each individual, wherein the storage module is further configured to store each of the historical data and the industry data.

Aspect 28. The system of aspect 25, wherein the processing module is further configured to differentiate a plurality of milestones associated with a common title, wherein the differentiating is based on the industry data.

Aspect 29. The system of aspect 21, wherein the processing module is further configured to:
a. identify a plurality of equivalent milestones across a plurality of career paths; and
b. form at least one bridge between the plurality of equivalent milestones of the plurality of career paths, wherein the storage module is further configured to store the at least one bridge.

Aspect 30. The system of aspect 29, wherein the processing module is further configured to identify at least one classification corresponding to each milestone, wherein identifying the plurality of equivalent milestones is based on the at least one classification.

Aspect 31. The system of aspect 29, wherein each milestone is associated with at least one of a title and a description, wherein identifying the plurality of equivalent milestones is based on a comparison between at least one of a title and a description of a first milestone with at least one of a title and a description of a second milestone.

Aspect 32. The system of aspect 30, wherein the processing module is further configured to decompose a title associated with a milestone into a plurality of standardized titles, wherein each standardized title is associated with a classification.

Aspect 33. The system of aspect 32, wherein the decomposing is performed based on a database of classifications, wherein the communication module is further configured to communicate with the database to facilitate the decomposing.

Aspect 34. The system of aspect 29, wherein the at least one potential career path is based on the at least one bridge.

Aspect 35. The system of aspect 34, wherein the processing module is further configured to:
a. receive at least one metric from the user; and
b. rank each potential career path based on the at least one metric, wherein transmitting the at least one potential career path is based on the ranking.

Aspect 36. The system of aspect 21, wherein the processing module is further configured to:
a. receive at least one metric from the user; and
b. rank each of a plurality of potential career paths based on the at least one metric, wherein presenting the at least one potential career path is based on the ranking.

Aspect 37. The system of aspect 21, wherein the target career goal comprises each of a job title, a job title area, an industry, and a location.

Aspect 38. The system of aspect 21, wherein the processing module is further configured to generate a graphical representation of the at least one career path, wherein each milestone comprised in the at least one career path is represented as a graphical object, wherein a visual characteristic of the graphical object is based on at least one metric associated with the milestone.

Aspect 39. The system of aspect 21, wherein each career path corresponding to an individual is associated with personal traits of the individual.

Aspect 40. The system of aspect 21, wherein the historical data further comprises mentor data provided by an individual of the plurality of individuals, wherein the mentor data is associated with at least one career path corresponding to the individual.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application.

The following is claimed:

1. A method of providing career path guidance, wherein the method is a computer implemented method, the method comprising:
a. receiving historical data associated with a plurality of individuals, wherein historical data associated with an individual comprises at least one of education history and work history;
b. analyzing the historical data;
c. identifying a plurality of career paths corresponding to the plurality of individuals based on the analyzing, wherein each individual is associated with at least one career path, wherein a career path comprises a plurality of milestones;
d. receiving a target career goal from a user;
e. identifying at least one potential career path from the plurality of career paths based on presence of at least one milestone associated with the target career goal in the at least one potential career path; and
f. presenting the at least one potential career path to the user.

2. The method of claim 1, wherein the historical data is extracted from a plurality of profiles corresponding to the plurality of individuals.

3. The method of claim 1 further comprising:
a. receiving at least one criteria associated with a path leading to the target career goal; and
b. identifying at least one optimal career path based on the at least one criteria.

4. The method of claim 1 further comprising receiving an entry point from the user, wherein identifying the at least one potential career path is further based on presence of the entry point in the at least one potential career path, wherein the at least one potential career path leads from the entry point to the target career goal.

5. The method of claim 1, wherein the historical data further comprises industry data associated with the plurality of milestones.

6. The method of claim 5, wherein the industry data comprises at least one of educational firmographics and company firmographics.

7. The method of claim 5 further comprising:
a. receiving the industry data from a source; and
b. associating the industry data with the plurality of milestones corresponding to each career path of each individual.

8. The method of claim 5 further comprising differentiating a plurality of milestones associated with a common title, wherein the differentiating is based on the industry data.

9. The method of claim 1 further comprising:
a. identifying a plurality of equivalent milestones across a plurality of career paths; and
b. forming at least one bridge between the plurality of equivalent milestones of the plurality of career paths.

10. The method of claim 9 further comprising identifying at least one classification corresponding to each milestone, wherein identifying the plurality of equivalent milestones is based on the at least one classification.

11. The method of claim 9, wherein each milestone is associated with at least one of a title and a description, wherein identifying the plurality of equivalent milestones is based on a comparison between at least one of a title and a description of a first milestone with at least one of a title and a description of a second milestone.

12. The method of claim 10 further comprises decomposing a title associated with a milestone into a plurality of standardized titles, wherein each standardized title is associated with a classification.

13. The method of claim 12, wherein the decomposing is performed based on a database of classifications.

14. The method of claim 9, wherein the at least one potential career path is based on the at least one bridge.

15. The method of claim 14 further comprising:
a. receiving at least one metric from the user; and
b. ranking each potential career path based on the at least one metric, wherein presenting the at least one potential career path is based on the ranking.

16. The method of claim 1 further comprising:
a. receiving at least one metric from the user; and
b. ranking each of a plurality of potential career paths based on the at least one metric, wherein presenting the at least one potential career path is based on the ranking.

17. The method of claim 1, wherein the target career goal comprises each of a job title, a job title area, an industry, and a location.

18. The method of claim 1, wherein the presenting comprises displaying a graphical representation of the at least one career path, wherein each milestone comprised in the at least one career path is represented as a graphical object, wherein a visual characteristic of the graphical object is based on at least one metric associated with the milestone.

19. The method of claim 1, wherein each career path corresponding to an individual is associated with personal traits of the individual.

20. A system for providing career path guidance, the system comprising:
a. a communication module configured to:
i. receive historical data associated with a plurality of individuals from at least one data source, wherein historical data associated with an individual comprises at least one of education history and work history;
ii. receive a target career goal from a user device associated with a user; and
iii. transmit at least one potential career path to the user;
b. a processing module configured to:
i. analyze the historical data;
ii. identify a plurality of career paths corresponding to the plurality of individuals based on the analyzing, wherein each individual is associated with at least one career path, wherein a career path comprises a plurality of milestones; and
iii. identify the at least one potential career path from the plurality of career paths based on presence of at least one milestone associated with the target career goal in the at least one potential career path;
and
c. a storage module configured to store the plurality of career paths.
